(19) United States
(12) Patent Application Publication
(10) Pub. No.: US 2018/0147437 A1
(43) Pub. Date: May 31, 2018

(54) MAGNETIC BRAKE CONTROL AND FLYWHEEL TRANSMISSION MODULE

(71) Applicant: Mu-Chuan WU, Tainan City (TW)

(72) Inventor: Mu-Chuan WU, Tainan City (TW)

(21) Appl. No.: 15/364,672

(22) Filed: Nov. 30, 2016

(51) Int. Cl. A63B 21/00; F16D 63/00; A63B 21/005; A63B 21/22; A63B 24/00; A63B 22/06; A63B 23/04

(52) U.S. Cl. CPC A63B 21/00192; F16D 63/002; A63B 21/005; A63B 23/0476; A63B 21/225; A63B 24/0087; A63B 22/0605; A63B 21/154

(57) ABSTRACT

The magnetic brake control and flywheel transmission module includes a mounting frame, a transmission shaft, a flywheel, a pulley assembly, and a magnetic brake control assembly. The transmission shaft and the flywheel are mounted on the mounting frame. The pulley assembly is disposed between the transmission shaft and the axle of the flywheel. The magnetic brake control assembly is mounted on the mounting frame, is disposed next to the flywheel, and applies a magnetic drag force on the flywheel. The modularly designed magnetic brake control and flywheel transmission module can be assembled in advance and then installed on a bike frame, so as to be suitable for use on different types of the bike frames.

### BACKGROUND OF THE INVENTION

1. Field of the Invention

The present invention relates to a magnetic brake control and flywheel transmission module for an exercise bike.

2. Description of the Prior Art(s)

An exercise bike is an indoor exercise equipment that allows an exerciser to exercise indoors regardless of the weather and the environment outdoors. Therefore, the exercise bikes are popular and are widely used.

Structures and ways to use a conventional exercise bike and an ordinary bicycle are similar. One of the differences between the conventional exercise bike and the ordinary bicycle is that the conventional exercise bike is used at a fixed position and the bicycle can be ridden to move forward. Moreover, the conventional exercise bike simulates difficulties of riding the bicycle by adjusting a drag force that is applied on the conventional exercise bike, so as to control training modes. Thus, the conventional exercise bike includes a bike frame, and a flywheel transmission mechanism and a magnetic brake control mechanism assembled on the bike frame. The drag force applied on a flywheel is adjusted via the magnetic brake control mechanism.

However, structural designs of different types of the conventional exercise bikes are distinct, so the bike frames of the different types of the conventional exercise bikes are different. Therefore, spatial arrangements of the magnetic brake control mechanism and the flywheel transmission mechanism have to be designed according to the bike frames of the different types of the conventional exercise bikes. The magnetic brake control mechanism and the flywheel transmission mechanism of one type of the conventional exercise bike are unable to be used on another type of the conventional exercise bike. Manufacturers should prepare manufacturing materials for the different types of the conventional exercise bikes. Accordingly, costs for material management and inventory are high.

To overcome the shortcomings, the present invention provides a magnetic brake control and flywheel transmission module to mitigate or obviate the aforementioned problems.

### SUMMARY OF THE INVENTION

The main objective of the present invention is to provide a magnetic brake control and flywheel transmission module. The magnetic brake control and flywheel transmission module includes a mounting frame, a transmission shaft, a flywheel, a pulley assembly, and a magnetic brake control assembly. The transmission shaft and the flywheel are mounted on the mounting frame. The pulley assembly is disposed between the transmission shaft and the axle of the flywheel. The magnetic brake control assembly is mounted on the mounting frame, is disposed next to the flywheel, and applies a magnetic drag force on the flywheel.

The modularly designed magnetic brake control and flywheel transmission module can be assembled in advance and then installed on a bike frame, so as to be suitable for use on different types of the bike frames. Accordingly, costs for material management and inventory can be efficiently reduced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a magnetic brake control and flywheel transmission module in accordance with the present invention;

FIG. 2 is another perspective view of the magnetic brake control and flywheel transmission module in FIG. 1;

FIG. 3 is an exploded perspective view of the magnetic brake control and flywheel transmission module in FIG. 1;

FIG. 4 is a side view of the magnetic brake control and flywheel transmission module in FIG. 1;

FIG. 5 is an operational side view of the magnetic brake control and flywheel transmission module in FIG. 1, shown assembled on a frame of an exercise bike; and

FIG. 6 is another operational side view of the magnetic brake control and flywheel transmission module in FIG. 1, shown assembled on a frame of another exercise bike.

### DETAILED DESCRIPTION OF THE PREFERRED EMBODIMENTS

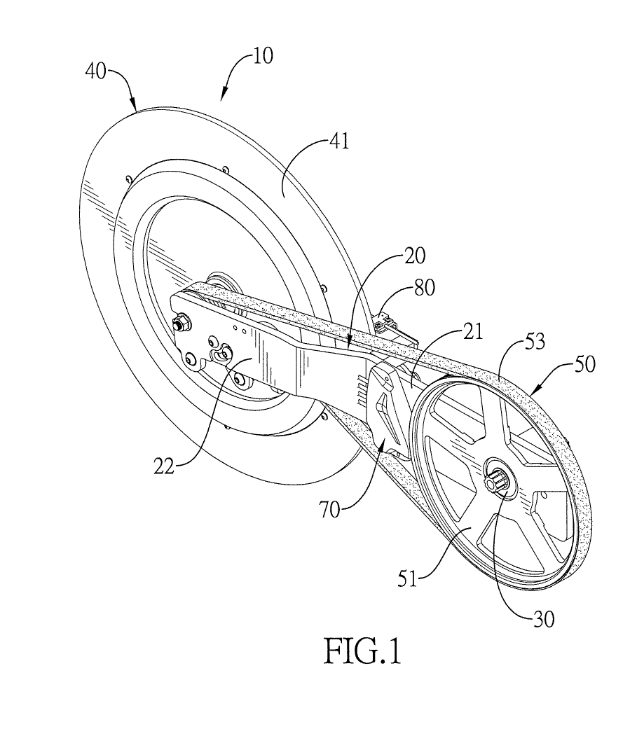

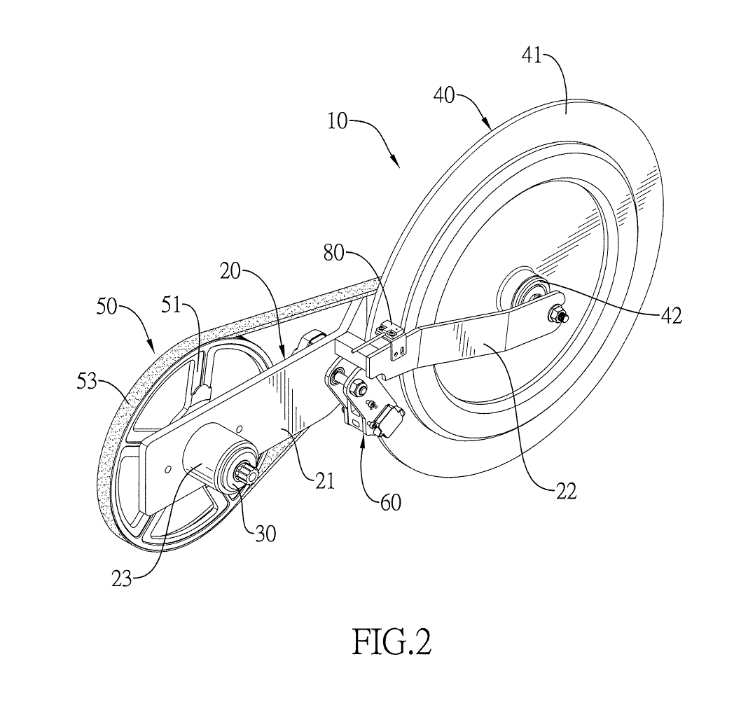

With reference to FIGS. 1 and 2, a magnetic brake control and flywheel transmission module 10 in accordance with the present invention comprises a mounting frame 20, a transmission shaft 30, a flywheel 40, a pulley assembly 50, and a magnetic brake control assembly 60.

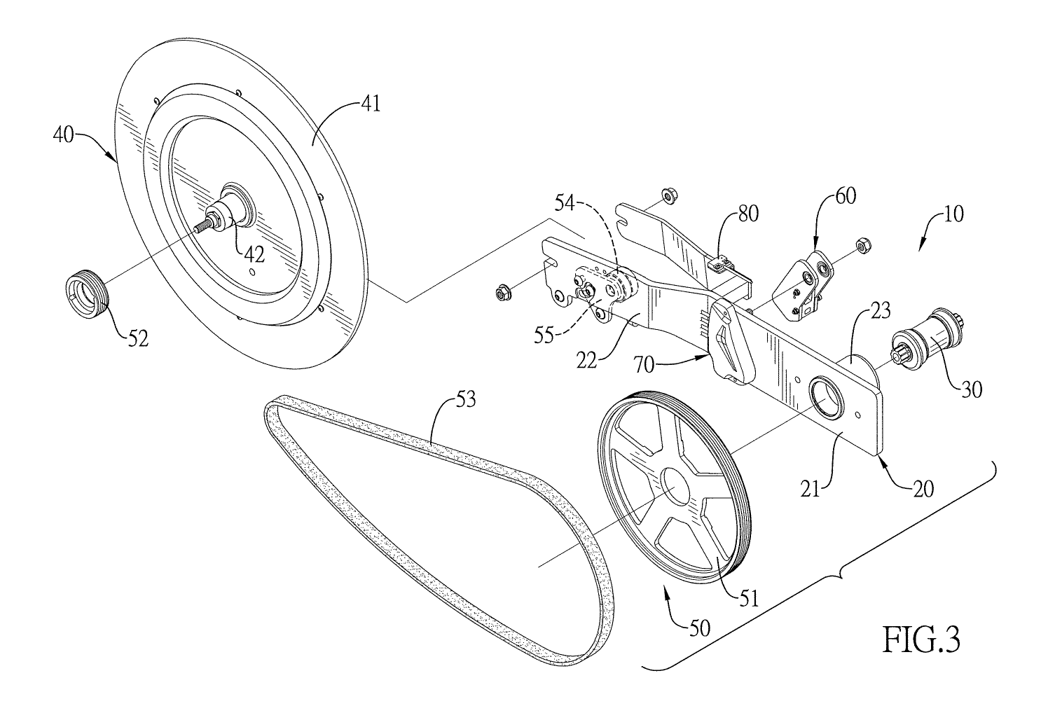

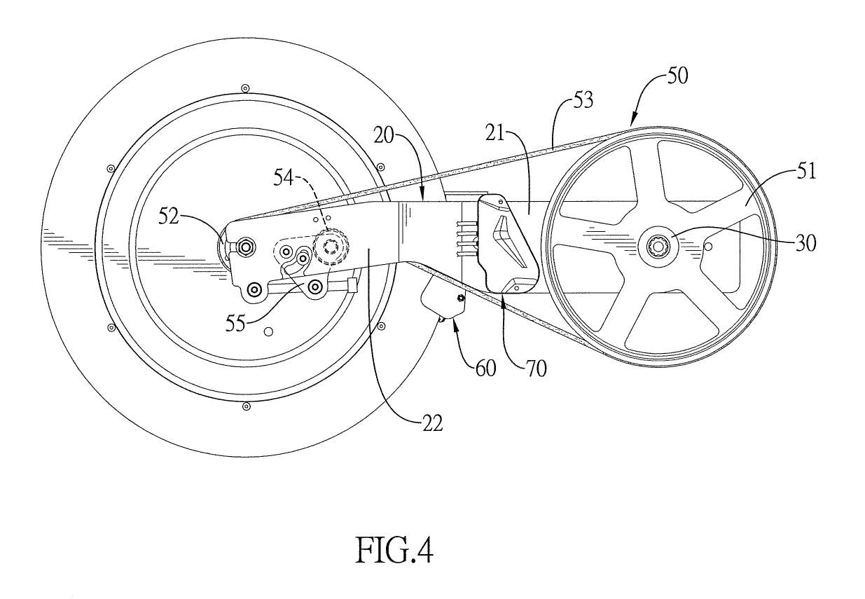

With reference to FIGS. 1 to 4, the mounting frame 20 has a base portion 21 and a fork portion 22. The fork portion 22 is disposed on an end of the base portion 21. In the preferred embodiment, the mounting frame 20 further has a shaft tube portion 23 disposed on the base portion 21.

With reference to FIGS. 1 to 4, the transmission shaft 30 is mounted on the base portion 21. In the preferred embodiment, the transmission shaft 30 is mounted in the shaft tube portion 23, which is disposed on the base portion 21.

With reference to FIGS. 1 to 4, the flywheel 40 is rotatably mounted on the fork portion 22 of the mounting frame 20 and includes a wheel 41 and an axle 42. The wheel 41 is mounted on the fork portion 22. The axle 42 is mounted at a center of the wheel 41 and has two ends. The two ends of the axle 42 are rotatably mounted to the fork portion 22.

With reference to FIGS. 1 to 4, the pulley assembly 50 is disposed between the transmission shaft 30 and the axle 42 of the flywheel 40 and includes a driving wheel 51, a driven wheel 52, and an annular belt 53. The driving wheel 51 is mounted on the transmission shaft 30. The driven wheel 52 is mounted on the axle 42 of the flywheel 40. A diameter of the driven wheel 52 is smaller than a diameter of the driving wheel 51. The annular belt 53 is mounted on and around the driving wheel 51 and the driven wheel 52 and drives the driving wheel 51 and the driven wheel 52 to rotate simultaneously.

In the preferred embodiment, the driving wheel 51 has multiple grooves formed in an outer peripheral surface of the driving wheel 51, the driven wheel 52 has multiple grooves formed in an outer peripheral surface of the driven wheel 52, and the annular belt 53 has multiple ribs formed on an inner peripheral surface of the annular belt 53. Each of the ribs of the annular belt 53 engages in a corresponding one of the grooves of the driving wheel 51 and a corresponding one of the grooves of the driven wheel 52.

With reference to FIGS. 1 to 4, the pulley assembly 50 may further include an idle wheel 54. The idle wheel 54 is mounted on the fork portion 22 of the mounting frame 20 via a positioning base 55 and abuts against an outer peripheral surface of the annular belt 53. Thus, the annular belt 53 can engage with the driving wheel 51 and the driven wheel 52 with a proper tightness.

In the preferred embodiment, the positioning base 55 is position-adjustably mounted on the fork portion 22 of the mounting frame 20, so as to adjust a position of the idle wheel 54 on the annular belt 53. By adjusting the positioning of the idle wheel 54 on the annular belt 53, the tightness between the annular belt 53 and the driving wheel 51 and between the annular belt 53 and the driven wheel 52 can be adjusted.

With reference to FIGS. 1 to 4, the magnetic brake control assembly 60 is mounted on the mounting frame 20, is disposed next to the flywheel 40, and applies a magnetic drag force on the flywheel 40.

With reference to FIGS. 1 to 4, the magnetic brake control and flywheel transmission module 10 may further comprise a signal converting component 70. The signal converting component 70 is mounted on the mounting frame 20, is electrically connected to the magnetic brake control assembly 60, and is controlled to adjust the magnetic drag force that the magnetic brake control assembly 60 applies on the flywheel 40.

With reference to FIGS. 1 to 4, the magnetic brake control and flywheel transmission module 10 may further comprise an angular measurement component 80. The angular measurement component 80 is mounted on the fork portion 22 of the mounting frame 20 and is disposed next to the flywheel 40. The angular measurement component 80 can detect the angle of a bike frame when the flywheel rotates.

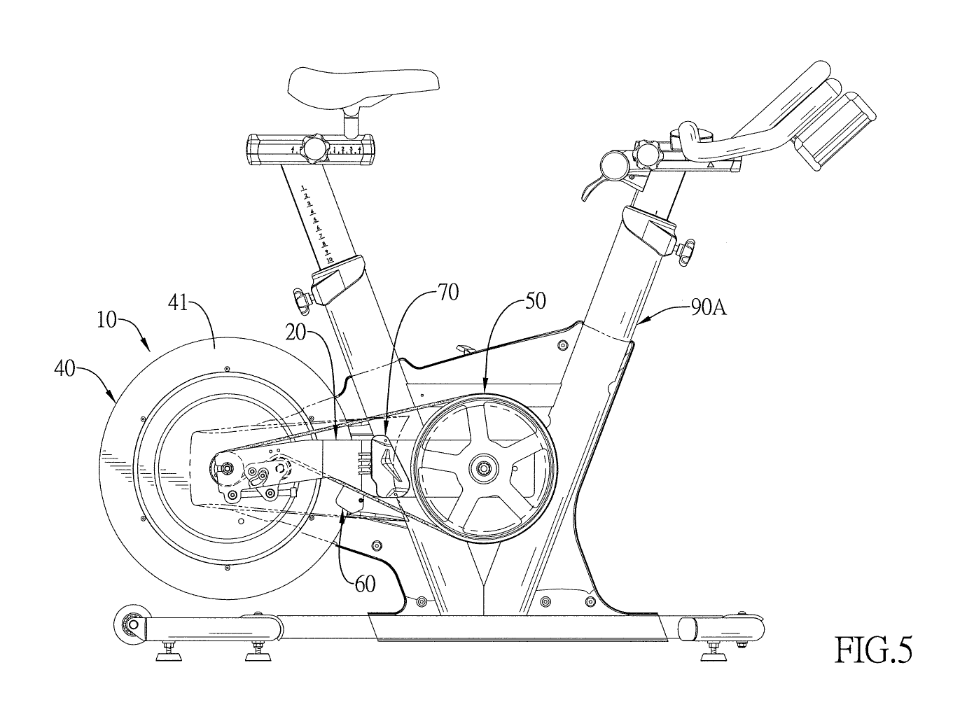

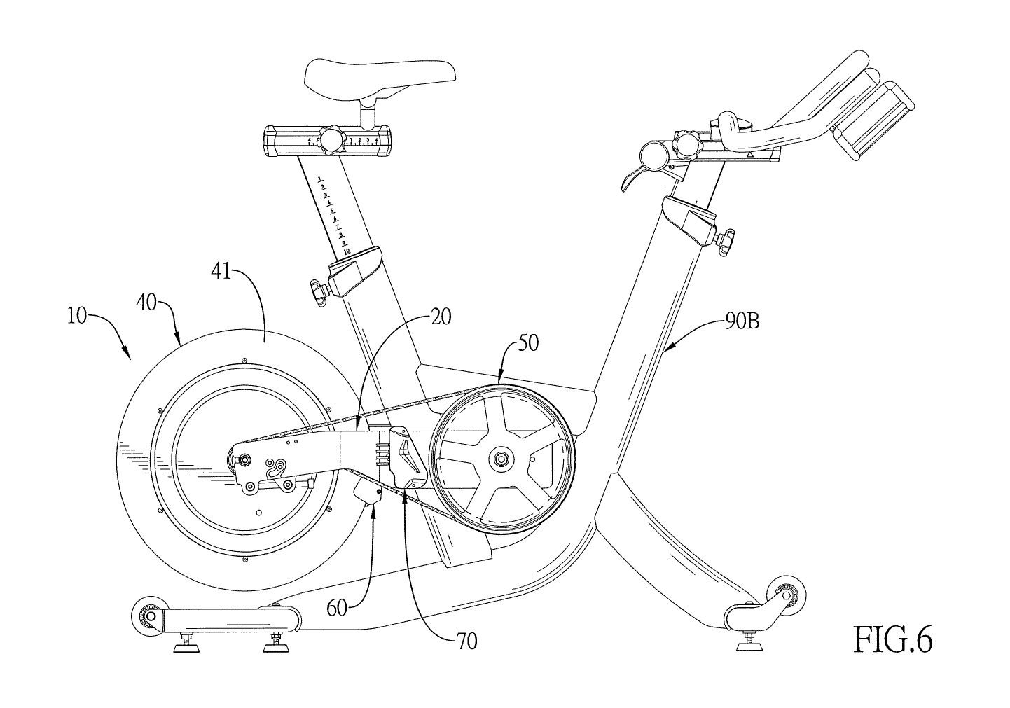

With further reference to FIGS. 5 and 6, the magnetic brake control and flywheel transmission module 10 as described can be assembled in advance and installed on a bike frame 90A, 90B by mounting the mounting frame 20 of the magnetic brake control and flywheel transmission module 10 on the bike frame 90A, 90B. Then a crank, pedals, a hub, and so forth are also installed on the bike frame 90A, 90B to form an exercise bike. The modularly designed magnetic brake control and flywheel transmission module 10 is suitable for use on the bike frames 90A, 90B of different types. Accordingly, costs for material management and inventory can be efficiently reduced. As for Watt value that is used for determining training intensity, since the magnetic brake control and flywheel transmission module 10 is modularly designed, cumulative error in the exercise bike can be reduced and accuracy for determining the Watt value can be increased.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A magnetic brake control and flywheel transmission module comprising:
a mounting frame having
a base portion; and
a fork portion disposed on an end of the base portion;
a transmission shaft mounted on the base portion of the mounting frame;
a flywheel rotatably mounted on the mounting frame and including
a wheel mounted on the fork portion; and
an axle mounted at a center of the wheel and having two ends rotatably mounted to the fork portion;
a pulley assembly disposed between the transmission shaft and the axle of the flywheel and including
a driving wheel mounted on the transmission shaft;
a driven wheel mounted on the axle of the flywheel;
wherein a diameter of the driven wheel is smaller than a diameter of the driving wheel; and
an annular belt mounted on and around the driving wheel and the driven wheel; and
a magnetic brake control assembly mounted on the mounting frame and disposed next to the flywheel.

2. The magnetic brake control and flywheel transmission module as claimed in claim 1, wherein
the driving wheel has multiple grooves formed in an outer peripheral surface of the driving wheel;
the driven wheel has multiple grooves formed in an outer peripheral surface of the driven wheel; and
the annular belt has multiple ribs formed on an inner peripheral surface of the annular belt, and each of the ribs of the annular belt engages in a corresponding one of the grooves of the driving wheel and a corresponding one of the grooves of the driven wheel.

3. The magnetic brake control and flywheel transmission module as claimed in claim 1, wherein the pulley assembly further includes an idle wheel, and the idle wheel is mounted on the fork portion of the mounting frame via a positioning base and abuts against an outer peripheral surface of the annular belt.

4. The magnetic brake control and flywheel transmission module as claimed in claim 2, wherein the pulley assembly further includes an idle wheel, and the idle wheel is mounted on the fork portion of the mounting frame via a positioning base and abuts against an outer peripheral surface of the annular belt.

5. The magnetic brake control and flywheel transmission module as claimed in claim 1, wherein
the mounting frame further has a shaft tube portion disposed on the base portion; and
the transmission shaft is mounted in the shaft tube portion.

6. The magnetic brake control and flywheel transmission module as claimed in claim 2, wherein
the mounting frame further has a shaft tube portion disposed on the base portion; and
the transmission shaft is mounted in the shaft tube portion.

7. The magnetic brake control and flywheel transmission module as claimed in claim 3, wherein
the mounting frame further has a shaft tube portion disposed on the base portion; and
the transmission shaft is mounted in the shaft tube portion.

8. The magnetic brake control and flywheel transmission module as claimed in claim 4, wherein
the mounting frame further has a shaft tube portion disposed on the base portion; and
the transmission shaft is mounted in the shaft tube portion.

9. The magnetic brake control and flywheel transmission module as claimed in claim 1 further comprising a signal converting component, and the signal converting component mounted on the mounting frame, electrically connected to the magnetic brake control assembly, and controlled to adjust a magnetic drag force that the magnetic brake control assembly applies on the flywheel.

10. The magnetic brake control and flywheel transmission module as claimed in claim 2 further comprising a signal converting component, and the signal converting component mounted on the mounting frame, electrically connected to the magnetic brake control assembly, and controlled to adjust a magnetic drag force that the magnetic brake control assembly applies on the flywheel.

11. The magnetic brake control and flywheel transmission module as claimed in claim 3 further comprising a signal converting component, and the signal converting component mounted on the mounting frame, electrically connected to the magnetic brake control assembly, and controlled to adjust a magnetic drag force that the magnetic brake control assembly applies on the flywheel.

12. The magnetic brake control and flywheel transmission module as claimed in claim 4 further comprising a signal converting component, and the signal converting component mounted on the mounting frame, electrically connected to the magnetic brake control assembly, and controlled to adjust a magnetic drag force that the magnetic brake control assembly applies on the flywheel.

13. The magnetic brake control and flywheel transmission module as claimed in claim 1 further comprising an angular measurement component, and the angular measurement component mounted on the fork portion of the mounting frame and disposed next to the flywheel.

14. The magnetic brake control and flywheel transmission module as claimed in claim 2 further comprising an angular measurement component, and the angular measurement component mounted on the fork portion of the mounting frame and disposed next to the flywheel.

15. The magnetic brake control and flywheel transmission module as claimed in claim 3 further comprising an angular measurement component, and the angular measurement component mounted on the fork portion of the mounting frame and disposed next to the flywheel.

16. The magnetic brake control and flywheel transmission module as claimed in claim 4 further comprising an angular measurement component, and the angular measurement component mounted on the fork portion of the mounting frame and disposed next to the flywheel.

17. The magnetic brake control and flywheel transmission module as claimed in claim 1 further comprising:
a signal converting component, and the signal converting component mounted on the mounting frame, electrically connected to the magnetic brake control assembly, and controlled to adjust a magnetic drag force that the magnetic brake control assembly applies on the flywheel; and
an angular measurement component, and the angular measurement component mounted on the fork portion of the mounting frame and disposed next to the flywheel.

18. The magnetic brake control and flywheel transmission module as claimed in claim 2 further comprising:
a signal converting component, and the signal converting component mounted on the mounting frame, electrically connected to the magnetic brake control assembly, and controlled to adjust a magnetic drag force that the magnetic brake control assembly applies on the flywheel; and
an angular measurement component, and the angular measurement component mounted on the fork portion of the mounting frame and disposed next to the flywheel.

19. The magnetic brake control and flywheel transmission module as claimed in claim 3 further comprising:
a signal converting component, and the signal converting component mounted on the mounting frame, electrically connected to the magnetic brake control assembly, and controlled to adjust a magnetic drag force that the magnetic brake control assembly applies on the flywheel; and
an angular measurement component, and the angular measurement component mounted on the fork portion of the mounting frame and disposed next to the flywheel.

20. The magnetic brake control and flywheel transmission module as claimed in claim 4 further comprising:
a signal converting component, and the signal converting component mounted on the mounting frame, electrically connected to the magnetic brake control assembly, and controlled to adjust a magnetic drag force that the magnetic brake control assembly applies on the flywheel; and
an angular measurement component, and the angular measurement component mounted on the fork portion of the mounting frame and disposed next to the flywheel.
